(19) United States
(12) Patent Application Publication
(10) Pub. No.: US 2024/0325971 A1
(43) Pub. Date: Oct. 3, 2024

(54) CARBON DIOXIDE TREATMENT DEVICE, CARBON DIOXIDE TREATMENT METHOD AND ETHYLENE PRODUCTION METHOD

(71) Applicant: HONDA MOTOR CO., LTD., Tokyo (JP)

(72) Inventor: Hiroshi Oikawa, Wako-shi (JP)

(21) Appl. No.: 18/588,058

(22) Filed: Feb. 27, 2024

(30) Foreign Application Priority Data
Mar. 29, 2023 (JP) 2023-053318

(51) Int. Cl. B01D 53/32; B01D 53/14

(52) U.S. Cl. CPC B01D 53/326; B01D 53/1475; B01D 2257/502; B01D 2257/504

(57) ABSTRACT

The present invention decreases the resistance of an electrolysis cell that is used for the reduction of carbon dioxide even under a strong alkaline condition and increases the electrolysis efficiency. The present invention provides a carbon dioxide treatment device including a collection device that collects carbon dioxide, a first electrochemical reaction part having a first electrolysis cell that electrochemically reduces the carbon dioxide collected with the collection device to carbon monoxide, a second electrochemical reaction part having a second electrolysis cell that electrochemically reduces the carbon monoxide generated in the first electrochemical reaction part to ethylene, and a microbubble generation part that supplies the carbon monoxide generated in the first electrochemical reaction part to the second electrochemical reaction part as microbubbles.

### BACKGROUND OF THE INVENTION

### Field of the Invention

The present invention relates to a carbon dioxide treatment device, a carbon dioxide treatment method and an ethylene production method.

### Description of Related Art

Conventionally, techniques for obtaining valuable materials by collecting carbon dioxide in exhaust gas or the atmosphere and electrochemically reducing the carbon dioxide are known. These techniques are promising techniques capable of achieving carbon neutrality, but economic efficiency is the biggest challenge. In order to improve the economic efficiency, it is important to increase the energy efficiency and decrease the loss of carbon dioxide in the collection and reduction of carbon dioxide.

As a technique for collecting carbon dioxide, a technique is known in which carbon dioxide in a gas state is physically or chemically absorbed to a solid or liquid absorbent, then, detached with energy such as heat and used. In addition, as a technique for electrochemically reducing carbon dioxide, a technique is known in which carbon dioxide gas is supplied to a cathode, in which a catalyst layer is formed on a side of a gas diffusion layer in contact with an electrolytic solution using a carbon dioxide reduction catalyst, from a side opposite to the catalyst layer of the gas diffusion layer and electrochemically reduced (for example, refer to Patent Document 1).

Conventionally, regarding the technique for collecting carbon dioxide and the technique for electrochemically reducing carbon dioxide, research and development has been underway separately. Therefore, in the case of combining each technique, the comprehensive energy efficiency or carbon dioxide loss decrease effect can be determined in a multiplier fashion from the efficiency of each technique, but there is room for additional improvement. As described above, it can be said that it is meaningful to increase the energy efficiency or the carbon dioxide loss decrease effect from a comprehensive viewpoint of combining the technique for collecting carbon dioxide and the technique for electrochemically reducing carbon dioxide.

### PATENT DOCUMENTS

[Patent Document 1] PCT International Publication No. WO 2018/232515

### SUMMARY OF THE INVENTION

Meanwhile, in the technique for electrochemically reducing carbon dioxide, when an attempt is made to selectively generate ethylene, it is advantageous that an electrolytic solution be under a strong alkaline condition. However, when a gas flow path for introducing carbon dioxide and a liquid flow path for introducing a strong alkaline electrolytic solution are installed with a cathode electrode having a gas-liquid separation function interposed therebetween in order to prevent the dissolution of carbon dioxide in the electrolytic solution, a cathode and an anode become more distant by the length of the liquid flow path, which increases the resistance of an electrolysis cell, which is used for the reduction of carbon dioxide, and creates a problem of a decrease in the electrolysis efficiency.

The present application aims to decrease the resistance of an electrolysis cell that is used for the reduction of carbon dioxide even under a strong alkaline condition and to increase the electrolysis efficiency in order to solve the above-described problem. In addition, furthermore, the present application contributes to an increase in the energy efficiency.

[1] A carbon dioxide treatment device, including a collection device that collects carbon dioxide, a first electrochemical reaction part having a first electrolysis cell that electrochemically reduces the carbon dioxide collected with the collection device to carbon monoxide, a second electrochemical reaction part having a second electrolysis cell that electrochemically reduces the carbon monoxide generated in the first electrochemical reaction part to ethylene, and a microbubble generation part that supplies the carbon monoxide generated in the first electrochemical reaction part to the second electrochemical reaction part as microbubbles.

Since the carbon dioxide treatment device of the present invention includes the microbubble generation part that supplies the carbon monoxide generated in the first electrochemical reaction part to the second electrochemical reaction part as microbubbles, the reaction efficiency between the carbon monoxide and water improves because the surface area of the microbubbles of the carbon monoxide becomes large, and the opportunity for contact with water increases. As a result, it is possible to decrease the resistance of the second electrolysis cell even under a strong alkaline condition and to increase the electrolysis efficiency.

[2] The carbon dioxide treatment device according to [1], in which the collection device includes a carbon dioxide absorption part that dissolves and absorbs carbon dioxide in a strong alkaline electrolytic solution, and
the carbon dioxide dissolved in the electrolytic solution in the carbon dioxide absorption part is supplied to the first electrochemical reaction part.

Since the carbon dioxide treatment device of the present invention includes the carbon dioxide absorption part, and the carbon dioxide dissolved in the electrolytic solution in the carbon dioxide absorption part is supplied to the first electrochemical reaction part, the concentration of carbon dioxide can be accelerated.

[3] The carbon dioxide treatment device according to [1] or [2], in which the first electrolysis cell includes a cathode, an anode, an ion exchange membrane provided between the cathode and the anode, a cathode-side liquid flow path that is provided adjacent to the cathode and through which the electrolytic solution containing the dissolved carbon dioxide flows, and an anode-side liquid flow path that is provided adjacent to the anode and through which the electrolytic solution flows, and
the second electrolysis cell includes a cathode, an anode, an ion exchange membrane provided between the cathode and the anode, a cathode-side gas flow path that is provided adjacent to the cathode and through which a gas flows, a cathode-side liquid flow path that is provided adjacent to the cathode and through which the electrolytic solution flows, and an anode-side liquid flow path that is provided adjacent to the anode and through which the electrolytic solution flows.

In the carbon dioxide treatment device of the present invention, carbon dioxide is electrochemically reduced to carbon monoxide with the first electrolysis cell, and the carbon monoxide generated with the first electrolysis cell is then electrochemically reduced to ethylene with the second electrolysis cell. That is, in the first electrolysis cell where the supplied carbon dioxide is dissolved and the alkalinity of the electrolytic solution becomes relatively weak, generation of carbon monoxide is aimed at intentionally. In addition, since carbon monoxide does not dissolve in the electrolytic solution and the electrolytic solution does not become weakly alkaline, carbon monoxide generated in the first electrolysis cell is supplied to the second electrolysis cell. This makes it possible to accelerate the electrochemical reduction reaction of carbon monoxide while preventing the electrolytic solution becoming weakly alkaline in the second electrolysis cell. Therefore, according to the carbon dioxide treatment device of the present invention, it is possible to selectively and efficiently generate ethylene.

[4] A carbon dioxide treatment method for electrochemically reducing carbon dioxide, the method including:
a first step of electrochemically reducing carbon dioxide to carbon monoxide with a first electrolysis cell,
a second step of supplying the carbon monoxide generated by the first step to a second electrolysis cell as microbubbles, and
a third step of electrochemically reducing the microbubbles of the carbon monoxide generated by the second step to ethylene.

Since the carbon dioxide treatment method of the present invention includes a first step of electrochemically reducing carbon dioxide to carbon monoxide with the first electrolysis cell, a second step of supplying the carbon monoxide generated by the first step to the second electrolysis cell as microbubbles, and a third step of electrochemically reducing the microbubbles of the carbon monoxide generated by the second step to ethylene, the reaction efficiency between the carbon monoxide and water improves because the surface area of the microbubbles of the carbon monoxide becomes large, and the opportunity for contact with water increases. As a result, it is possible to decrease the resistance of the second electrolysis cell even under a strong alkaline condition and to increase the electrolysis efficiency.

[5] An ethylene production method for producing ethylene by reducing carbon dioxide by the carbon dioxide treatment method according to [4].

In the ethylene production method of the present invention, since ethylene is produced by reducing carbon dioxide by the carbon dioxide treatment method of the present invention, ethylene can be efficiently produced.

According to the present invention, it is possible to decrease the resistance of an electrolysis cell that is used for the reduction of carbon dioxide under a strong alkaline condition and to increase the electrolysis efficiency.

### BRIEF DESCRIPTION OF THE DRAWINGS

FIG. 1 is a schematic view illustrating a carbon dioxide treatment device according to an embodiment of the present invention.

FIG. 2 is a schematic cross-sectional view illustrating an example of an electrolysis cell in a first electrochemical reaction part in the carbon dioxide treatment device according to the embodiment of the present invention.

FIG. 3 is a schematic cross-sectional view illustrating an example of an electrolysis cell in a second electrochemical reaction part in the carbon dioxide treatment device according to the embodiment of the present invention.

### DETAILED DESCRIPTION OF THE INVENTION

Hereinafter, embodiments of the present invention will be described in detail with reference to drawings.

### [Carbon Dioxide Treatment Device]

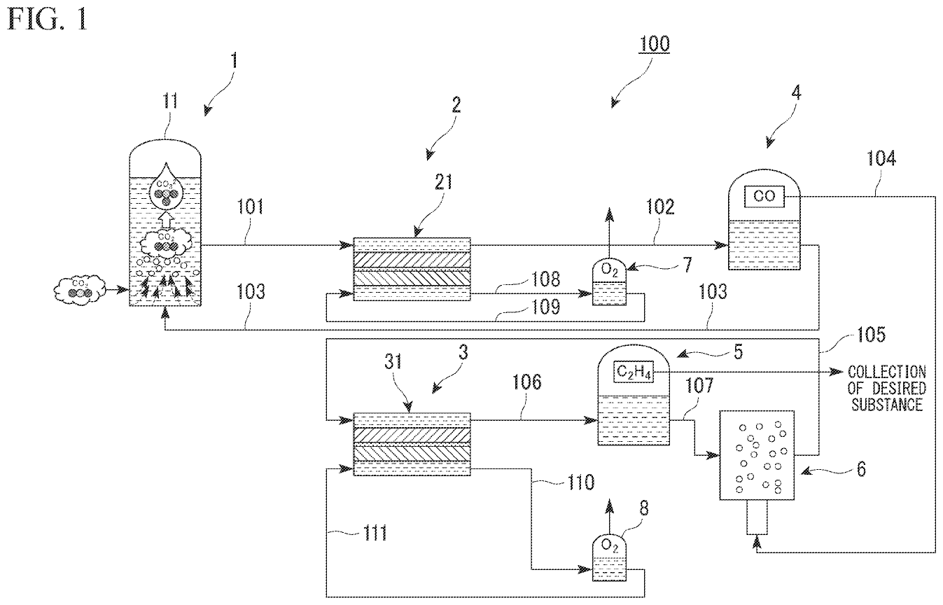

FIG. 1 is a schematic view illustrating a carbon dioxide treatment device 100 according to an embodiment of the present invention. As illustrated in FIG. 1, the carbon dioxide treatment device 100 according to the embodiment of the present invention includes a collection device 1, a first electrochemical reaction part 2, a second electrochemical reaction part 3, a first gas-liquid separation part 4, a second gas-liquid separation part 5 and a microbubble generation part 6. In addition, the carbon dioxide treatment device 100 according to the embodiment of the present invention may include a first oxygen separation part 7 and a second oxygen separation part 8.

The collection device 1 includes a CO₂ absorption part 11.

The first electrochemical reaction part 2 includes a first electrolysis cell 21.

The second electrochemical reaction part 3 includes a second electrolysis cell 31.

In the carbon dioxide treatment device 100, the CO₂ absorption part 11 and the first electrolysis cell 21 are connected to each other through a liquid flow path 101. The first electrolysis cell 21 and the first gas-liquid separation part 4 are connected to each other through a liquid flow path 102. The first gas-liquid separation part 4 and the CO₂ absorption part 11 are connected to each other through a liquid flow path 103. The first gas-liquid separation part 4 and the microbubble generation part 6 are connected to each other through a gas flow path 104. The microbubble generation part 6 and the second electrolysis cell 31 are connected to each other through a liquid flow path 105. The second electrolysis cell 31 and the second gas-liquid separation part 5 are connected to each other through a liquid flow path 106. The second gas-liquid separation part 5 and the microbubble generation part 6 are connected to each other through a liquid flow path 107. The first electrolysis cell 21 and the first oxygen separation part 7 are connected to each other through liquid flow paths 108 and 109. The second electrolysis cell 31 and the second oxygen separation part 8 are connected to each other through liquid flow paths 110 and 111.

Each of the above-described flow paths is not particularly limited, and a well-known pipe or the like can be used as appropriate. In the gas flow path 104, air supply means such as a compressor, a valve, measuring equipment such as a flow rate meter or the like can be installed as appropriate. In addition, in the liquid flow paths 101, 102, 103, 105, 106 and 107, liquid-feeding means such as a pump, a valve, measuring equipment such as a flow rate meter or the like can be installed as appropriate.

The collection device 1 is configured to collect carbon dioxide. To the CO₂ absorption part 11, a gas containing carbon dioxide such as air or exhaust gas is supplied. In the CO₂ absorption part 11, carbon dioxide gas in the gas comes into contact with an electrolytic solution, and carbon dioxide is dissolved and absorbed in the electrolytic solution. Means for bringing the carbon dioxide gas and the electrolytic solution into contact with each other is not particularly limited, and, for example, a method for bubbling by blowing the gas into the electrolytic solution can be exemplified.

In the CO₂ absorption part 11, as an absorption liquid that absorbs carbon dioxide, an electrolytic solution composed of a strong alkaline aqueous solution is used. In carbon dioxide, the oxygen atoms strongly attract electrons, and the carbon atom thus have positive charges (6+). Therefore, in a strong alkaline aqueous solution where a large number of hydroxide ions are present, the dissolution reaction of carbon dioxide from a hydration state to CO₃²⁻ through HCO₃⁻ proceeds easily, and an equilibrium state where the abundance ratio of CO₃²⁻ is high is formed. This makes it easy for carbon dioxide to dissolve in a strong alkaline aqueous solution compared with other gases such as nitrogen, hydrogen and oxygen and makes the carbon dioxide in the gas be selectively absorbed in the electrolytic solution in the CO₂ absorption part 11. As described above, the use of the electrolytic solution in the CO₂ absorption part 11 makes it possible to accelerate the concentration of carbon dioxide.

The electrolytic solution in which the carbon dioxide has been absorbed in the CO₂ absorption part 11 is fed to the first electrochemical reaction part 2 through the liquid flow path 101.

As the strong alkaline aqueous solution that is used for the electrolytic solution, a potassium hydroxide aqueous solution and a sodium hydroxide aqueous solution can be exemplified. Of the two, a potassium hydroxide aqueous solution is preferably used from the viewpoint of having excellent properties of dissolving carbon dioxide in the CO₂ absorption part 11 and the acceleration of the reduction of carbon dioxide in the first electrochemical reaction part 2.

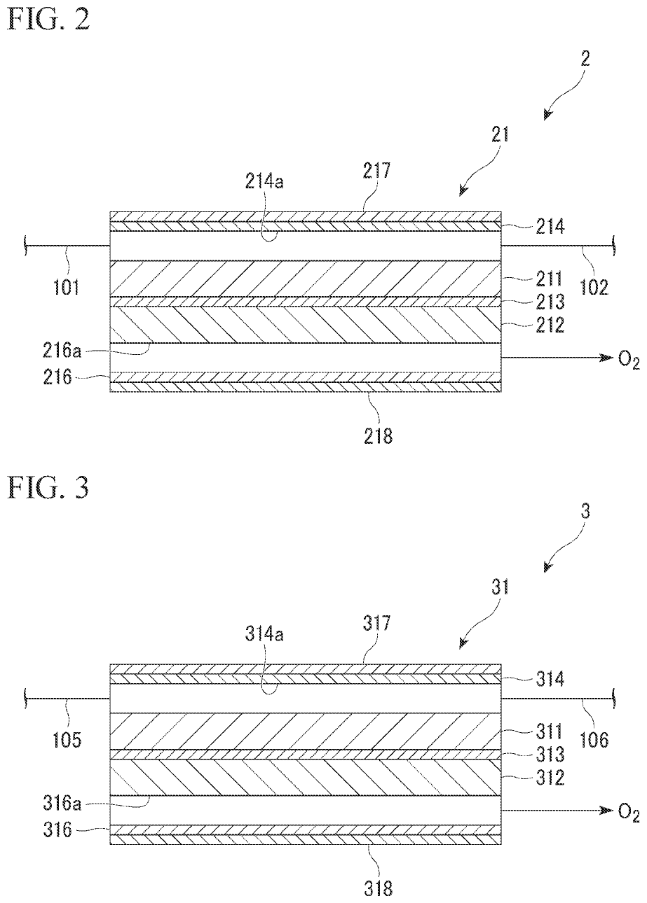

FIG. 2 is a schematic cross-sectional view illustrating an example of the first electrochemical reaction part 2. The first electrochemical reaction part 2 includes the first electrolysis cell 21 as an electrolysis cell. In the first electrochemical reaction part 2, carbon dioxide is electrochemically reduced with the first electrolysis cell 21. In more detail, in the first electrochemical reaction part 2, in a reaction path of obtaining ethylene as a desired product by the electrochemical reduction reaction of carbon dioxide, a reduction reaction of carbon dioxide to carbon monoxide is carried out. While one electrolysis cell is illustrated in FIG. 2, the first electrochemical reaction part 2 preferably includes an electrolysis cell stack configured by laminating a plurality of electrolysis cells each provided with the first electrolysis cell 21.

As illustrated in FIG. 1, the first electrolysis cell 21 is disposed upstream of the second electrolysis cell 31 of the second electrochemical reaction part 3, which will be described below.

As illustrated in FIG. 2, the first electrolysis cell 21 includes a cathode 211, an anode 212, an ion exchange membrane 213, a cathode-side liquid flow path structure 214 that forms a cathode-side liquid flow path 214a, an anode-side liquid flow path structure 216 that forms an anode-side liquid flow path 216a, a power feeder 217 and a power feeder 218.

In the first electrolysis cell 21, the power feeder 217, the cathode-side liquid flow path structure 214, the cathode 211, the ion exchange membrane 213, the anode 212, the anode-side liquid flow path structure 216 and the power feeder 218 are laminated in this order. In addition, the cathode-side liquid flow path 214a is formed between the cathode 211 and the cathode-side liquid flow path structure 214, and the anode-side liquid flow path 216a is formed between the anode 212 and the anode-side liquid flow path structure 216. The cathode-side liquid flow path 214a and the anode-side liquid flow path 216a are provided at positions facing each other across the cathode 211, the ion exchange membrane 213 and anode 212. The number of each of the cathode-side liquid flow path 214a and the anode-side liquid flow path 216a provided is preferably plural, and the shape thereof may be a linear shape or a zigzag shape.

The power feeder 217 and the power feeder 218 are electrically connected to an electric energy storage part, not illustrated. In addition, the cathode-side liquid flow path structure 214 and the anode-side liquid flow path structure 216 are both conductors and are configured to be capable of applying a voltage between the cathode 211 and the anode 212 with power that is supplied from the electric energy storage part.

The cathode 211 is an electrode that reduces carbon dioxide. In more detail, the cathode 211 in the first electrolysis cell 21 mainly reduces carbon dioxide to carbon monoxide. Here, part of the generated carbon monoxide may be reduced to ethylene.

As the cathode 211, for example, an electrode including a gas diffusion layer and a cathode catalyst layer formed on the cathode-side liquid flow path 214a side of the gas diffusion layer can be exemplified. The cathode catalyst layer may be disposed to be partially inserted into the gas diffusion layer. In addition, a porous layer that is denser than the gas diffusion layer may be disposed between the gas diffusion layer and the cathode catalyst layer.

As a cathode catalyst that forms the cathode catalyst layer, a well-known catalyst that is used for the reduction reaction of carbon dioxide can be used. Specific examples of the cathode catalyst include metals such as gold, silver, copper, platinum, palladium, nickel, cobalt, iron, manganese, titanium, cadmium, zinc, indium, gallium, lead and tin, alloys and intermetallic compounds thereof and metal complexes such as a ruthenium complex and a rhenium complex. Among them, examples of a preferable cathode catalyst for the reduction reaction of carbon dioxide to carbon monoxide include silver, gold and zinc. One cathode catalyst may be singly used or two or more cathode catalysts may be jointly used. As the cathode catalyst, a supported catalyst containing metal particles supported by a carbon material (carbon particles, carbon nanotubes, graphene or the like) may also be used.

The gas diffusion layer in the cathode 211 is not particularly limited, and, for example, carbon paper and carbon cloth can be exemplified. A method for producing the cathode 211 is not particularly limited, and examples thereof include a method in which a slurry of a liquid composition containing the cathode catalyst is applied and dried on the surface of the gas diffusion layer that is to be on the cathode-side liquid flow path 214a side.

The anode 212 is an electrode that oxidizes hydroxide ions to generate oxygen. As the anode 212, for example, an electrode including a gas diffusion layer and an anode catalyst layer formed on the anode-side liquid flow path 216a side of the gas diffusion layer can be exemplified. The anode catalyst layer may be disposed to be partially inserted into the gas diffusion layer. In addition, a porous layer that is denser than the gas diffusion layer may be disposed between the gas diffusion layer and the anode catalyst layer.

An anode catalyst that forms the anode catalyst layer is not particularly limited, and a well-known anode catalyst can be used. Specific examples thereof include metals such as platinum, palladium and nickel, alloys and intermetallic compounds thereof, metal oxides such as manganese oxide, iridium oxide, nickel oxide, cobalt oxide, iron oxide, tin oxide, indium oxide, ruthenium oxide, lithium oxide and lanthanum oxide and metal complexes such as a ruthenium complex and a rhenium complex. One anode catalyst may be singly used or two or more anode catalysts may be jointly used.

As the gas diffusion layer in the anode 212, for example, carbon paper and carbon cloth can be exemplified. In addition, as the gas diffusion layer, a porous body such as a mesh material, a punching material, p s or a metal fiber sintered body may also be used. As the material of the porous body, for example, metals such as titanium, nickel and iron and alloys thereof (for example, SUS) can be exemplified.

As the material of the cathode-side liquid flow path structure 214 and the anode-side liquid flow path structure 216, for example, metals such as titanium and SUS and carbon can be exemplified.

As the material of the power feeder 217 and the power feeder 218, for example, metals such as copper, gold, titanium and SUS and carbon can be exemplified. As the power feeder 217 and the power feeder 218, a power feeder obtained by performing a plating treatment such as gold plating on the surface of a copper base material may also be used.

In addition, as illustrated in FIG. 1, the second electrolysis cell 31 in the second electrochemical reaction part 3 is disposed downstream of the first electrolysis cell 21.

As illustrated in FIG. 3, the second electrolysis cell 31 includes a cathode 311, an anode 312, an ion exchange membrane 313, a cathode-side liquid flow path structure 314 that forms a cathode-side liquid flow path 314a, an anode-side liquid flow path structure 316 that forms an anode-side liquid flow path 316a, a power feeder 317 and a power feeder 318.

In the second electrolysis cell 31, the power feeder 317, the cathode-side liquid flow path structure 314, the cathode 311, the ion exchange membrane 313, the anode 312, the anode-side liquid flow path structure 316 and the power feeder 318 are laminated in this order. In addition, the cathode-side liquid flow path 314a is formed between the cathode 311 and the cathode-side liquid flow path structure 314, and the anode-side liquid flow path 316a is formed between the anode 312 and the anode-side liquid flow path structure 316. The cathode-side liquid flow path 314a and the anode-side liquid flow path 316a are provided at positions facing each other across the cathode 311, the ion exchange membrane 313 and anode 312. The number of each of the cathode-side liquid flow path 314a and the anode-side liquid flow path 316a provided is preferably plural, and the shape thereof may be a linear shape or a zigzag shape.

The power feeder 317 and the power feeder 318 are electrically connected to an electric energy storage part, not illustrated. In addition, the cathode-side liquid flow path structure 314 and the anode-side liquid flow path structure 316 are both conductors and are configured to be capable of applying a voltage between the cathode 311 and the anode 312 with power that is supplied from the electric energy storage part.

As described below, the cathode 311 reduces a gas mainly containing the carbon monoxide generated by the reduction of carbon dioxide with the first electrolysis cell 21. In more detail, the cathode 311 in the second electrolysis cell 31 is an electrode that reduces carbon monoxide to ethylene. In addition, the cathode 311 is also capable of reducing unreacted carbon dioxide that has not been reduced to carbon monoxide with the first electrolysis cell 21 to ethylene.

As the cathode 311, for example, an electrode including a gas diffusion layer and a cathode catalyst layer formed on the cathode-side liquid flow path 314a side of the gas diffusion layer can be exemplified. The cathode catalyst layer may be disposed to be partially inserted into the gas diffusion layer. In addition, a porous layer that is denser than the gas diffusion layer may be disposed between the gas diffusion layer and the cathode catalyst layer.

As a cathode catalyst that forms the cathode catalyst layer, a well-known catalyst that is used for the reduction reaction of carbon dioxide can be used. Specific examples of the cathode catalyst include metals such as gold, silver, copper, platinum, palladium, nickel, cobalt, iron, manganese, titanium, cadmium, zinc, indium, gallium, lead and tin, alloys and intermetallic compounds thereof and metal complexes such as a ruthenium complex and a rhenium complex. Among them, preferable examples of a cathode catalyst for the reduction reaction of carbon dioxide to carbon monoxide include silver, gold and zinc. One cathode catalyst may be singly used or two or more cathode catalysts may be jointly used. As the cathode catalyst, a supported catalyst containing metal particles supported by a carbon material (carbon particles, carbon nanotubes, graphene or the like) may also be used.

The gas diffusion layer in the cathode 311 is not particularly limited, and, for example, carbon paper and carbon cloth can be exemplified. A method for producing the cathode 311 is not particularly limited, and examples thereof include a method in which a slurry of a liquid composition containing the cathode catalyst is applied and dried on the surface of the gas diffusion layer that is to be on the cathode-side liquid flow path 314a side.

The anode 312 is an electrode that oxidizes hydroxide ions to generate oxygen. As the anode 312, for example, an electrode including a gas diffusion layer and an anode catalyst layer formed on the anode-side liquid flow path 316a side of the gas diffusion layer can be exemplified. The anode catalyst layer may be disposed to be partially inserted into the gas diffusion layer. In addition, a porous layer that is denser than the gas diffusion layer may be disposed between the gas diffusion layer and the anode catalyst layer.

An anode catalyst that forms the anode catalyst layer is not particularly limited, and a well-known anode catalyst can be used. Specific examples thereof include metals such as platinum, palladium and nickel, alloys and intermetallic compounds thereof, metal oxides such as manganese oxide, iridium oxide, nickel oxide, cobalt oxide, iron oxide, tin oxide, indium oxide, ruthenium oxide, lithium oxide and lanthanum oxide and metal complexes such as a ruthenium complex and a rhenium complex. One anode catalyst may be singly used or two or more anode catalysts may be jointly used.

As the gas diffusion layer in the anode 312, for example, carbon paper and carbon cloth can be exemplified. In addition, as the gas diffusion layer, a porous body such as a mesh material, a punching material, a porous body or a metal fiber sintered body may also be used. As the material of the porous body, for example, metals such as titanium, nickel and iron and alloys thereof (for example, SUS) can be exemplified.

As the material of the cathode-side liquid flow path structure 314 and the anode-side liquid flow path structure 316, for example, metals such as titanium and SUS and carbon can be exemplified.

As the material of the power feeder 317 and the power feeder 318, for example, metals such as copper, gold, titanium and SUS and carbon can be exemplified. As the power feeder 317 and the power feeder 318, a power feeder obtained by performing a plating treatment such as gold plating on the surface of a copper base material may also be used.

The first gas-liquid separation part 4 separates carbon monoxide from the electrolytic solution containing the carbon monoxide generated with the first electrolysis cell 21 in the first electrochemical reaction part 2 to collect carbon monoxide.

The second gas-liquid separation part 5 separates ethylene from the electrolytic solution containing the ethylene generated with the second electrolysis cell 31 in the second electrochemical reaction part 3 to collect ethylene.

The microbubble generation part 6 supplies the carbon monoxide collected with the first gas-liquid separation part 4 to the second electrolysis cell 31 in the second electrochemical reaction part 3 as microbubbles.

The first oxygen separation part 7 separates oxygen from the electrolytic solution containing the oxygen generated with the first electrolysis cell 21 in the first electrochemical reaction part 2 to collect oxygen.

The second oxygen separation part 8 separates oxygen from the electrolytic solution containing the oxygen generated with the second electrolysis cell 31 in the second electrochemical reaction part 3 to collect oxygen.

The reduction reaction of carbon dioxide with the first electrolysis cell 21 and the second electrolysis cell 31 will be described.

The first electrolysis cell 21 is a flow cell where the electrolytic solution that is supplied from the CO₂ absorption part 11 and fed through the liquid flow path 101 flows into the cathode-side liquid flow path 214a. When a voltage is applied to the cathode 211 and the anode 212, dissolved carbon dioxide in the electrolytic solution that flows through the cathode-side liquid flow path 214a is electrochemically reduced in the cathode 211. The electrolytic solution at the inlet of the cathode-side liquid flow path 214a contains dissolved carbon dioxide and thus has a relatively high abundance ratio of CO₃²⁻0 and is in a weak alkaline state. On the other hand, as the electrolytic solution flows through the cathode-side liquid flow path 214a and the reduction proceeds, the amount of the dissolved carbon dioxide, that is, the amount of CO₃²⁻ in the electrolytic solution, decreases, and the electrolytic solution returns to a strong alkaline state at the outlet of the cathode-side liquid flow path 214a.

As described above, in the cathode 211 in the first electrolysis cell 21, since the electrolytic solution is under a relatively weak alkaline condition, a product that is produced by the reduction of carbon dioxide is mainly carbon monoxide. Specifically, in the cathode 211, a reaction represented by the following cathode half reaction proceeds, and carbon monoxide is thereby generated as a gas-phase product. The generated gas-phase carbon monoxide flows out from the outlet of the cathode-side liquid flow path 214a.

2CO₃²⁻+4H₂O→2CO+8OH⁻ [Cathode half reaction]

Hydroxide ions generated in the cathode 211 in the first electrolysis cell 21 permeate through the ion exchange membrane 213, migrate to the anode 212 and are oxidized by a reaction represented by the following anode half reaction, whereby oxygen is generated. The generated oxygen permeates through the gas diffusion layer of the anode 212, flows into the anode-side liquid flow path 216a and flows out from the outlet of the anode-side liquid flow path 216a.

4OH⁻→O₂+2H₂O [Anode half reaction]

Therefore, in the first electrolysis cell 21, as a whole, a reaction represented by the following overall reaction proceeds.

2CO₃²⁻+2H₂O→2CO+O₂+4OH⁻ [Overall reaction]

As described above, in the carbon dioxide treatment device 100 of the present embodiment, the electrolytic solution that is used in the first electrochemical reaction part 2 is commonly used as the electrolytic solution in the CO₂ absorption part 11, and carbon dioxide dissolved in the electrolytic solution is supplied to the first electrochemical reaction part 2 and electrochemically reduced. This decreases energy necessary for the detachment of carbon dioxide and makes it possible to increase the energy efficiency compared with a case where, for example, carbon dioxide is absorbed to an absorbent, detached by heating and reduced.

Here, as described above, the electrolytic solution at the inlet of the cathode-side liquid flow path 214a contains dissolved carbon dioxide and is thus in a weak alkaline state where the abundance ratio of CO₃²⁻ is high. In contrast, in the reduction reaction of carbon dioxide, since it is difficult for the reduction reaction to proceed under a weak alkaline condition, there is a problem in that the production efficiency of desired ethylene is poor. Therefore, as described above, the gas that flows out from the outlet of the cathode-side liquid flow path 214a in the first electrolysis cell 21 is mainly carbon monoxide.

In contrast, in the carbon dioxide treatment device 100 of the present embodiment, the gas mainly containing carbon monoxide that flows out from the outlet of the cathode-side liquid flow path 214a in the first electrolysis cell 21 is collected in the first gas-liquid separation part 4 and supplied to the microbubble generation part 6 through the gas flow path 104, the carbon monoxide is made into microbubbles in the microbubble generation part 6, the carbon monoxide that has been made into microbubbles is dispersed in the electrolytic solution discharged from the second electrolysis cell 31 in the second electrochemical reaction part 3 to produce an electrolytic solution, and the electrolytic solution is supplied to the second electrolysis cell 31 in the second electrochemical reaction part 3 through the liquid flow path 105.

The second electrolysis cell 31 is a flow cell where the carbon monoxide that has been made into microbubbles and is supplied from the microbubble generation part 6 through the liquid flow path 105 flows into the cathode-side liquid flow path 314a.

When a voltage is applied to the cathode 311 and the anode 312, the carbon monoxide that flows through the cathode-side liquid flow path 314a is electrochemically reduced in the cathode 311, whereby ethylene is generated.

Specifically, in the cathode 311 in the second electrolysis cell 31, a reaction represented by the following cathode half reaction proceeds, and ethylene is thereby generated as a gas-phase product. The carbon monoxide that has been made into microbubbles and is supplied from the microbubble generation part 6 through the liquid flow path 105 does not dissolve in the electrolytic solution, and there is no case where the electrolytic solution becomes weakly alkaline. Therefore, in the cathode 311 in the second electrolysis cell 31, the reduction reaction of the carbon monoxide proceeds efficiently, and consequently, ethylene is efficiently generated.

2CO+4H₂O→C₂H₄+4OH⁻ [Cathode half reaction]

Hydroxide ions generated in the cathode 311 in the second electrolysis cell 31 permeate through the ion exchange membrane 313, migrate to the anode 312 and are oxidized by a reaction represented by the following anode half reaction, whereby oxygen is generated. The generated oxygen permeates through the gas diffusion layer of the anode 312, flows into the anode-side liquid flow path 316a and flows out from the outlet of the anode-side liquid flow path 316a.

4OH⁻→O₂+2H₂O [Anode half reaction]

Therefore, in the second electrolysis cell 31, as a whole, a reaction represented by the following overall reaction proceeds.

2CO+2H₂O→C₂H₄+2O₂ [Overall reaction]

Since the carbon dioxide treatment device of the present embodiment includes the microbubble generation part 6 that makes the carbon monoxide generated in the first electrochemical reaction part 2 into microbubbles and supplies the microbubbles to the second electrochemical reaction part 3, the reaction efficiency between the carbon monoxide and water improves because the surface area of the microbubbles of the carbon monoxide becomes large, and the opportunity for contact with water increases. As a result, it is possible to decrease the resistance of the second electrolysis cell 31 even under a strong alkaline condition and to increase the electrolysis efficiency.

### [Carbon Dioxide Treatment Method]

A carbon dioxide treatment method according to an embodiment of the present invention is carried out using, for example, the above-described carbon dioxide treatment device 100. Specifically, the carbon dioxide treatment method of the present embodiment preferably includes a step (a) of bringing carbon dioxide gas into contact with an electrolytic solution composed of a strong alkaline aqueous solution in the CO₂ absorption part 11, and dissolving and absorbing carbon dioxide in the electrolytic solution, a step (b) of electrochemically reducing dissolved carbon dioxide in the electrolytic solution to carbon monoxide in the first electrolysis cell 21, a step (c) of making the carbon monoxide generated in the step (b) into microbubbles with the microbubble generation part 6 and supplying the microbubbles to the second electrolysis cell 31 and a step (d) of electrochemically reducing the microbubbles of the carbon monoxide generated in the step (c) to ethylene with the second electrolysis cell 31. The carbon dioxide treatment method of the present embodiment can be used in an ethylene production method.

In addition, a characteristic of the carbon dioxide treatment method of the present embodiment is to include the step (c) of making the carbon monoxide generated in the step (b) into microbubbles with the microbubble generation part 6 and supplying the microbubbles to the second electrolysis cell 31.

The present invention is not limited to each of the above aspects, and modifications and improvements to an extent that the objective of the present invention can be achieved are included in the present invention.

### EXPLANATION OF REFERENCES

1 Collection device
2 First electrochemical reaction part
3 Second electrochemical reaction part
4 First gas-liquid separation part
Second gas-liquid separation part
6 Microbubble generation part
7 First oxygen separation part
8 Second oxygen separation part
11 CO₂ absorption part
21 First electrolysis cell
31 Second electrolysis cell
100 Carbon dioxide treatment device
211,311 Cathode
212,312 Anode
213, 313 Ion exchange membrane
214, 314 Cathode-side liquid flow path structure
214a, 314a Cathode-side liquid flow path
216, 316 Anode-side liquid flow path structure
216a, 316a Anode-side liquid flow path
217, 218, 317, 318 Power feeder

What is claimed is:

1. A carbon dioxide treatment device, comprising:
a collection device that collects carbon dioxide;
a first electrochemical reaction part having a first electrolysis cell that electrochemically reduces the carbon dioxide collected with the collection device to carbon monoxide;
a second electrochemical reaction part having a second electrolysis cell that electrochemically reduces the carbon monoxide generated in the first electrochemical reaction part to ethylene; and
a microbubble generation part that supplies the carbon monoxide generated in the first electrochemical reaction part to the second electrochemical reaction part as microbubbles.

2. The carbon dioxide treatment device according to claim 1,
wherein the collection device includes a carbon dioxide absorption part that dissolves and absorbs carbon dioxide in a strong alkaline electrolytic solution, and
the carbon dioxide dissolved in the electrolytic solution in the carbon dioxide absorption part is supplied to the first electrochemical reaction part.

3. The carbon dioxide treatment device according to claim 1,
wherein the first electrolysis cell includes a cathode, an anode, an ion exchange membrane provided between the cathode and the anode, a cathode-side liquid flow path that is provided adjacent to the cathode and through which the electrolytic solution containing the dissolved carbon dioxide flows, and an anode-side liquid flow path that is provided adjacent to the anode and through which the electrolytic solution flows, and
the second electrolysis cell includes a cathode, an anode, an ion exchange membrane provided between the cathode and the anode, a cathode-side gas flow path that is provided adjacent to the cathode and through which a gas flows, a cathode-side liquid flow path that is provided adjacent to the cathode and through which the electrolytic solution flows, and an anode-side liquid flow path that is provided adjacent to the anode and through which the electrolytic solution flows.

4. A carbon dioxide treatment method for electrochemically reducing carbon dioxide, the method comprising:
a first step of electrochemically reducing carbon dioxide to carbon monoxide with a first electrolysis cell;
a second step of supplying the carbon monoxide generated by the first step to a second electrolysis cell as microbubbles; and
a third step of electrochemically reducing the microbubbles of the carbon monoxide generated by the second step to ethylene.

5. An ethylene production method for producing ethylene by reducing carbon dioxide by the carbon dioxide treatment method according to claim 4.
